(19) United States
(12) Patent Application Publication
(10) Pub. No.: US 2016/0221419 A1
(43) Pub. Date: Aug. 4, 2016

(54) RADIATOR TANK FOR A MOTOR VEHICLE

(71) Applicant: WEIDPLAS GMBH, Rapperswil (CH)

(72) Inventors: Colin CIANELLI, Zürich (CH); Christian BÖLSTERLI, Dürnten (CH); Piero DAL VECCHIO, Ermenswil (CH); Armin MÜLLER, Kaltbrunn (CH)

(73) Assignee: WEIDPLAS GmbH, Rapperswil (CH)

(21) Appl. No.: 15/022,082

(22) PCT Filed: Sep. 11, 2014
(86) PCT No.: PCT/EP2014/069343

§ 371 Date: Mar. 15, 2016

(30) Foreign Application Priority Data
Sep. 16, 2013 (EP) 13184552.1

(51) Int. Cl. B60H 1/28

(52) U.S. Cl. CPC B60H 1/28

(57) ABSTRACT

The radiator tank comprises a deflection chamber (2) comprising a top wall (3); a bottom wall (4) having a water outflow hole (9); an air inlet hole (10); and an air outlet hole (11). Inside the deflection chamber (2) a deflection element (12) is arranged, by which air charged with water droplets and flowing in through the air inlet opening (10) is deflected. The air inlet opening (10) is arranged in the top wall (3) and/or in a front wall (5) and the air outlet opening (11) is arranged in the top wall (3) and/or in a rear wall (6). A flow hole (15) is arranged between at least one side wall (7, 8) of the deflection chamber (2) and a side edge (36) of the deflection element (12). Near said flow hole (15) at least one guide structure (53) is provided to guide air flowing through the deflection chamber (2) around the side edge (36) of the deflection element (12).

The invention relates to a water box for a motor vehicle.

Water boxes of this type are arranged in motor vehicles, in particular below the engine hood, and serve to provide fresh air from the surroundings for the air-conditioning of the vehicle interior. For example in the event of rain, the suctioned fresh air is loaded with water droplets. Additionally, splash water may enter the water box through the suction opening. So that air which is as dry as possible is able to be supplied to the air-conditioning unit, in the water box both splash water and water droplets and/or spray from the fresh air are to be conducted as effectively as possible into the water drainage opening in the bottom wall and discharged there. The degree of efficiency of the water removal should be as high as possible so that as few water droplets as possible enter the vehicle interior and, in particular, the air filter of the air-conditioning unit. An increasingly important aspect of such a water box is the energy consumption, which is required in order to provide fresh air to the air-conditioning unit. Generally, the fresh air is suctioned by means of a fan. The energy consumption is, in particular, dependent on the resistance to which the suctioned fresh air is subjected in the water box. By enlarging the water box this resistance may be reduced. However, this is countered by the requirement that the constructional volume of a water box should be as small as possible.

A water box of the aforementioned type is disclosed in the prior art in DE-C-199 23 193. In order to improve the efficiency of the water removal, an air-permeable roof body is arranged in the deflection chamber above the air outlet opening. Said roof body bears, on the one hand, against a rear wall and, on the other hand, against a front wall and forms flow openings with side walls. On the roof body which here forms the deflection element, the air flowing through the water box is deflected in two directions oriented transversely to one another. The high degree of efficiency is intended to be achieved by the majority of water droplets entrained in the fresh air not being able to follow the dual deflection on the roof body. It is assumed that due to their inertia the water droplets fall down into the water drainage opening.

A water box has been disclosed in DE-B-10 2004 051 198 which consists of a water removal chamber and a droplet removal chamber. Primarily splash water in the water removal chamber and droplets in the droplet removal chamber are intended to be removed from the air. A water box with two chambers is relatively costly in production and has a relatively large constructional volume. In this case, the resistance and thus the energy consumption would probably be relatively high.

A water box is disclosed in the as yet unpublished European application EP 12 163 910.8, in which the air flowing through a front wall and flowing out through a rear wall in the horizontal direction is deflected by a deflection element. In order to reduce the air resistance in the event that the air flowing in is dry, the deflection element is able to be pivoted such that the air flowing through is only partially deflected or not deflected at all. In the case of moist air, however, the deflection produces a relatively high resistance.

The object of the invention is to provide a water box of the aforementioned type which has a relatively low resistance and thus ensures a relatively low energy consumption during use. Additionally, the water box is intended to permit water removal with a high degree of efficiency.

To achieve this object a water box is proposed as specified in claim 1. Advantageous embodiments of the invention are disclosed in the dependent claims.

The present invention thus provides a water box for a motor vehicle comprising a deflection chamber which comprises a top wall, a bottom wall with a water drainage opening, an air inlet opening and an air outlet opening. A deflection element is arranged in the deflection chamber, air flowing in through the air inlet opening and loaded with water droplets being deflected thereon. The air inlet opening is arranged in the top wall and/or a front wall and the air outlet opening is arranged in the top wall and/or in a rear wall. A flow opening is arranged between at least one side wall of the deflection chamber and a side edge of the deflection element. At least one guide structure is provided in the deflection chamber in the region of the flow opening in order to guide air which flows through the deflection chamber around the side edge of the deflection element.

Due to the guide structure, turbulence of the airflow which is produced, for example, in the region of the side edge of the deflection element, is reduced or even substantially eliminated. Instead of producing turbulence, the air is passed along the guide structure around the side edge of the deflection element. As turbulence may be reduced or even substantially avoided, a substantial reduction in resistance results for the air flowing through the water box. This leads to a reduced energy consumption by the air conveying means, the fresh air being suctioned thereby.

The water box produces, in particular, a low resistance if the air inlet opening is arranged in the front wall and/or the air outlet opening is arranged in the rear wall, as then the air has to be deflected less often when flowing through the deflection chamber.

The air may be guided particularly easily, in particular, around the side edge of the deflection element if the guide structure is arranged at least partially downstream in the airflow relative to the deflection element.

Preferably, the deflection element extends substantially from the top wall to the bottom wall, more preferably the deflection element extends from the top wall to the bottom wall.

A water box which, in particular, has very low resistance results when the deflection element extends substantially from the top wall to the bottom wall, and when the air inlet opening is arranged in the front wall and the air outlet opening is arranged in the rear wall, wherein a flow opening is arranged between at least one side wall of the deflection chamber and a side edge of the deflection element. In such a water box, the air flows substantially horizontally through the deflection chamber.

Preferably, the guide structure also extends substantially from the top wall to the bottom wall, more preferably from the top wall to the bottom wall, whereby the air flow guidance around the deflection element may take place in a manner which is particularly free of turbulence and thus low in resistance.

Fresh air flowing through the air inlet opening into the deflection chamber is deflected on the deflection element and guided by the guide structure around the deflection element and finally enters the air outlet opening. On the front face of the deflection element, splash water is deflected and guided to the water drainage opening. At the same time, on this front face, water droplets are removed from the air and said water droplets then drop down due to their inertia and also into the aforementioned water drainage opening. According to a development of the invention, the deflection element and/or the guide structure substantially extend in the vertical direction.

The degree of efficiency of the water removal is particularly high if according to a development of the invention the water drainage opening is arranged between the deflection element and the rear wall. The water drainage opening is then located on the leeward side of the deflection element. If the guide structure has a part arranged at least partially downstream in the air flow relative to the deflection element, this part advantageously extends in the direction of the water drainage opening so that the water flowing around the guide structure and/or the air flowing around the guide structure is substantially guided to the water drainage opening.

In a development of the invention, the guide structure extends in cross section over an angular range of at least 90° and, in particular, at most 180° around the side edge of the deflection element. The guide structure in this case preferably has a curved inner surface as well as an outer surface curved in the same direction as the inner surface. Advantageously, the side edge is also of curved configuration and preferably the side edge is then curved in the same direction as the curved inner surface of the guide structure.

The guide structure is preferably sickle-shaped in cross section. Thus it preferably has an inner surface with an inner radius and an outer surface with an outer radius which is larger compared to the inner radius. A sickle-shaped guide structure is advantageous, therefore, as it generally initially subdivides an air flow slowly in order to guide it, on the one hand, along the inner surface and, on the other hand, along the outer surface around the deflection element, and finally slowly combines it without the occurrence of strong turbulence. This shape of guide structure may additionally also produce a Coand\check{a} effect due to which the air flow is guided particularly effectively around the deflection element. In order to produce as little turbulence as possible, the inner surface and the outer surface of the guide structure in each case are preferably free of local raised portions and depressions. The inner surface of the guide structure generally faces the side edge of the deflection element.

Advantageously, the deflection element in cross section has a thickness which in a region of the deflection element arranged adjacent to the flow opening, increases toward the side edge by a multiple and in particular continuously. This region, in particular, represents a bead-like thickened portion of the deflection element in the region of the side edge extending in the vertical direction. The side edge is then preferably formed by the thickened portion. Due to this thickened portion of the deflection element it is possible to avoid stall and thus air turbulence in the region of the side edge. The thickened portion may be configured, in particular in cross section, at least in the shape of a pitch circle, wherein the circular region extends over an angular range of preferably at least 180, in particular preferably at least 270°.

According to a development of the invention, the water box has an inlet pipe which opens into the air inlet opening of the deflection chamber, wherein preferably a transition region of rounded configuration is provided between the inlet pipe and the deflection chamber. Experiments have shown that the presence of an inlet pipe, which in particular has a circular cross-sectional surface, reduces the air resistance which the water box exerts on the air flowing through. A transition region of rounded configuration prevents stall and thus associated air turbulence in the region of the air inlet opening.

A further increase in the efficiency of the water removal is achieved if the deflection element has a second side edge which forms a second flow opening with a second side wall of the deflection chamber. The first and the second flow openings are preferably substantially symmetrically arranged so that the fresh air flowing into the deflection chamber is subdivided symmetrically. The deflection element in this case is, in particular, configured to be in the shape of a gabled roof. The ridge of the gabled roof thus extends substantially vertically. The two parts of the gabled roof are preferably of concave configuration on the front face. Preferably, in such an embodiment with a second side edge and a second flow opening in the deflection chamber at least one second guide structure is present in the region of the second flow opening in order to guide air which flows through the deflection chamber around the second side edge of the deflection element. The first and the second guide structures are preferably configured substantially symmetrically to one another and arranged such that, in particular, the two airflows subdivided by the deflection element are guided around the respective side edge by the two guide structures and brought together again on the rear face relative to the deflection element.

In one preferred embodiment, the deflection chamber and the deflection element together form and/or delimit at least one first air channel and a second air channel running separately from the first air channel. The first and the second air channels extend, in particular, in each case along one of the side walls and are separated from one another by the deflection element. Particularly preferably, the first air channel and the second air channel in each case have a substantially uniform flow cross section relative to surface and shape. In this manner, as far as possible a laminar flow, i.e. a flow without turbulence, may be ensured in the two air channels. The first air channel in this case advantageously extends substantially from the air inlet opening to the first flow opening and the second air channel advantageously extends substantially from the air inlet opening to the second flow opening.

The guide structure may be connected, for example, via one or more web connections to the deflection element and/or a side wall of the deflection chamber. Preferably, however, the guide structure is arranged as a whole spaced apart from the deflection element and/or spaced apart from the side walls of the deflection chamber. An inner air through-opening is preferably provided in the region of the flow opening between the guide structure and the side edge of the deflection element and an outer air through-opening is provided between the guide structure and the side wall of the deflection chamber. The outer air through-opening is preferably dimensioned so as to be larger in comparison with the inner air through-opening. In the region of the guide structure the inner air through-opening and the outer air through-opening in each case preferably have a substantially uniform cross section relative to surface and shape. The inner air through-opening advantageously has an outlet opening arranged downstream in the airflow which is oriented substantially in the direction of the water drainage opening.

A particularly low flow resistance may be achieved if according to a development of the invention the air inlet opening and the air outlet opening are arranged at substantially the same height above the bottom wall. Thus these two openings are in this case arranged opposite one another. The suctioned fresh air flows substantially horizontally from the air inlet opening into the air outlet opening.

According to a development of the invention, it is provided that the bottom wall is configured to be conical such that the water drainage opening is located at the lowest point of the bottom wall. The splash water and the water removed from the air thus reach the water drainage opening in a particularly efficient manner.

According to a development of the invention, it is provided that the deflection chamber has at least partially rounded edges between the walls. Thus the resistance and thus the energy consumption may be reduced further. Rounded edges and/or transition regions may produce, in particular, a Coand\check{a} effect. Advantageously, in particular, the transition regions between the front wall and the side walls and/or between the side walls and the rear wall are of rounded configuration in each case. The transition regions between the side walls and the rear wall are advantageously configured in each case to be curved in the same direction as the outer surface(s) of the guide structure(s) remote from the deflection element. The transition regions between the side walls and the rear wall also extend, in particular, in each case substantially parallel to the outer surface of the guide structure facing the respective transition region. The transition regions between the front wall and the side walls are advantageously configured in each case to be curved in the same direction as the surface of the deflection element facing the respective side wall. The transition regions between the front wall and the side walls also extend, in particular, in each case substantially parallel to the surface of the deflection element facing the respective side wall. Rounded transition regions may also be provided between the front wall, the side walls, the rear wall and the top wall as well as the front wall, the side walls, the rear wall and the bottom wall.

The deflection element may have at least one part which is able to be adjusted between a first position and a second position, wherein in the first position this part deflects flowing air for the water removal and in the second position opens up a through-passage so that the air is able to flow in a manner which is as unhindered as possible through the deflection chamber. If the ambient air is dry, for example in the case of dry weather during summer, a removal of the water in the water box is not necessary. In this case, at least one part of the deflection element is in a position in which it provides no resistance to the air flowing through. This part is, for example, a wall which in the second position is oriented parallel to the direction of throughflow. This at least one part may, in particular, be pivotable about a substantially vertical axis. Preferably, two parts which form the deflection element and which are pivotable between two positions are provided. In the one position, they form the deflection element at which, as described above, water is removed from the fresh air. In the other position these two parts are pivoted such that said parts produce substantially no deflection of the air flowing through. According to a development of the invention, the two parts are, similar to a double door, pivotable relative to one another in a mirror-symmetrical manner. The guide structure and/or, if several are to be present, the guide structures may be pivoted, but do not have to be able to be pivoted, with one respective part of the deflection element.

The at least one movable part of the deflection element may be controlled, for example, by means of a moisture sensor. The aforementioned part is thus, for example, controlled such that it is pivoted away into an inactive position if the moisture content falls below a predetermined value. If the moisture value exceeds the stated limit, the aforementioned part possibly together with the guide structure, is moved, for example pivoted, again into the active and/or deflecting position.

According to a development of the invention it is provided that the guide structure, in particular the inner surface and/or outer surface thereof, and preferably at least one side edge of the deflection element are rounded according to the Coand\check{a} effect. As a result, the water to be removed and/or the air is particularly effectively guided around the deflection element and, in particular, water is guided particularly effectively into the water drainage opening. By means of this effect, in particular, improved deflection may be achieved and undesired flow separation avoided.

According to a development of the invention, the deflection element and/or the guide structure with their respective upper faces bear against the top wall and/or with their respective lower faces bear against the bottom wall or are directly connected to the top wall and/or the bottom wall. Preferably, the deflection element and/or the guide structure with their respective upper faces continuously bear against the top wall or are continuously directly connected to the top wall, i.e. no gap and/or no through-openings are present between the deflection element and/or guide structure and the top wall. Alternatively or additionally, the deflection element and/or the guide structure with their respective lower faces preferably bear continuously against the bottom wall or are continuously connected directly to the bottom wall. As a result, in the regions adjacent to the top and bottom, all fresh air flowing past is deflected on the deflection element and/or guided by the guide structure around the deflection element. If the deflection element and/or the guide structure bear continuously against the top wall and continuously against the bottom wall and/or are connected directly to said walls, all fresh air entering is deflected on the deflection element and/or on the guide structure, and only then enters the air outlet opening. On the front face of the deflection element, in this case all splash water is deflected and guided to the water drainage opening. In alternative embodiments, however, it is also conceivable that the upper face and/or lower face of the deflection element and/or the guide structure is at least partially spaced apart from the top wall and/or bottom wall. In this case, the deflection element and/or the guide structure on its upper face and/or lower face, may be connected, for example at the side, to at least one of the side walls, without a direct connection being present between the deflection element and the top wall and/or bottom wall.

According to a development of the invention, at least one web is attached to the upper face of the bottom wall in order to guide water which collects on the floor to the water drainage opening, in particular from the air inlet opening to the inner air through-opening.

The surfaces of the deflection chamber, the deflection element and/or the guide structure are advantageously not configured to be completely smooth which means that they have a surface roughness Ra of at least 1 micrometer. The surface roughness Ra in this case is measured according to the standard DIN EN ISO 3274 (Issued Jan. 4, 1998). The surfaces may be configured, in particular, to be embossed. It has been shown that the water removal from the air flowing through the water box is thereby improved.

The invention further relates to a motor vehicle with a water box according to the invention. The water box is attached to an air suction device, suctioned fresh air being able to be discharged thereby into the passenger compartment. The air suction device is preferably part of an air-conditioning unit and has a fan which is conventional per se.

Further advantageous features are disclosed in the dependent claims, the following description and the drawings.

Exemplary embodiments of the invention are described in more detail hereinafter with reference to the drawings, in which:

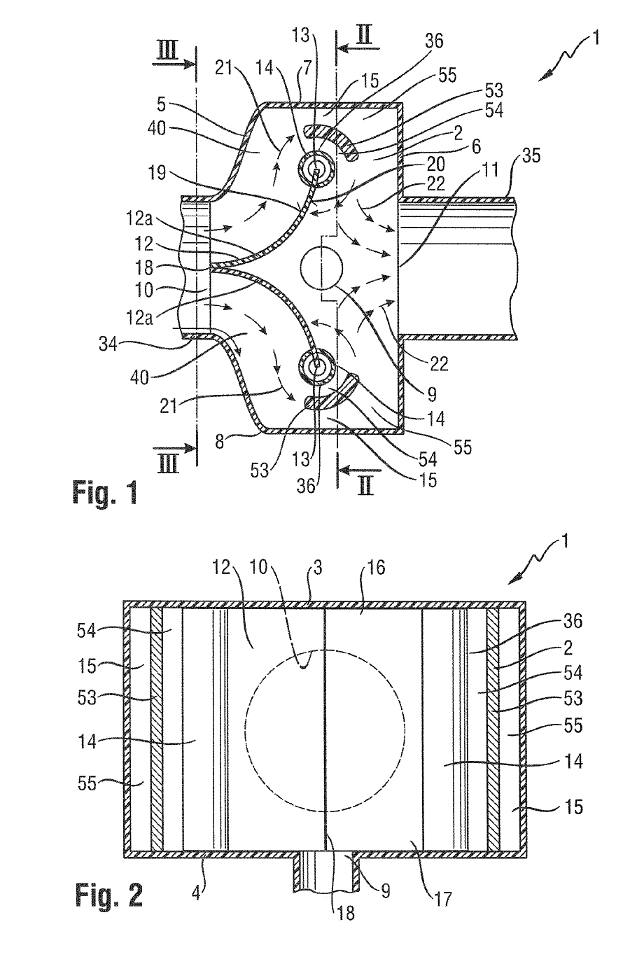

FIG. 1 shows a horizontal section through a schematically shown water box according to the invention,

FIG. 2 shows a vertical section through the water box along the line II-II of FIG. 1,

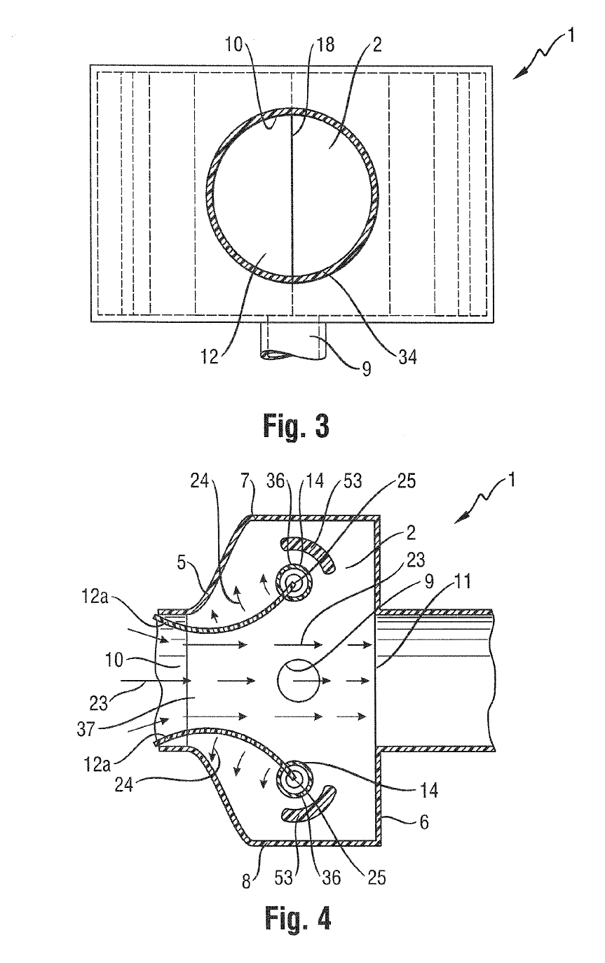

FIG. 3 shows a section through the water box along the line III-III of FIG. 1,

FIG. 4 shows the section according to FIG. 1, wherein the deflection element is not active, however, and therefore the fresh air is able to flow unhindered through the water box,

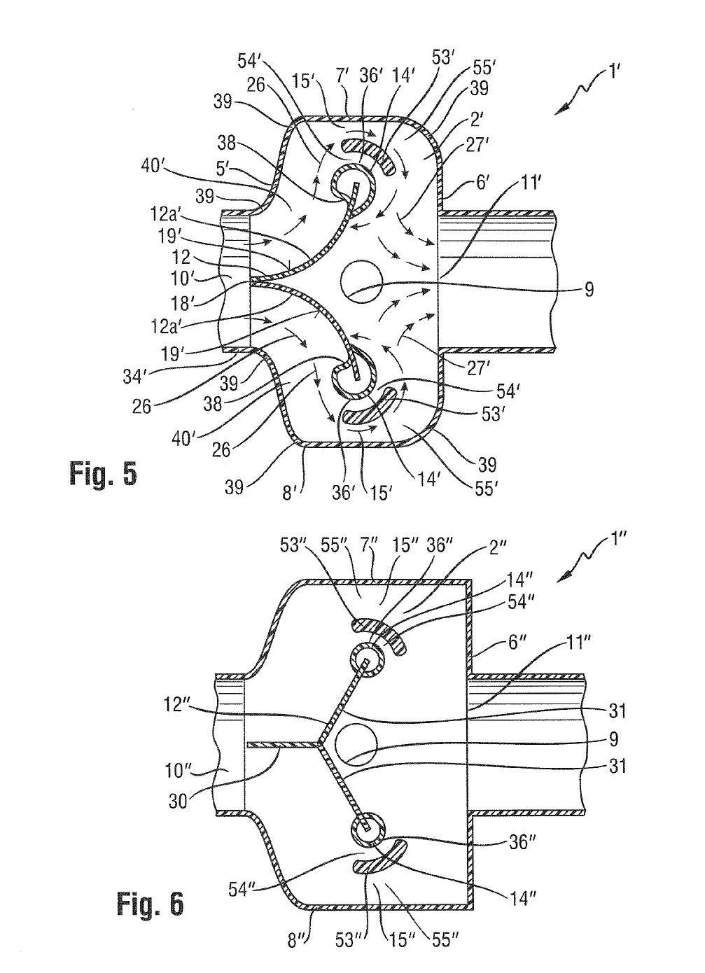

FIG. 5 shows a horizontal section through a schematically shown water box according to the invention according to a variant,

FIG. 6 shows a horizontal section through a schematically shown water box according to the invention according to a further variant,

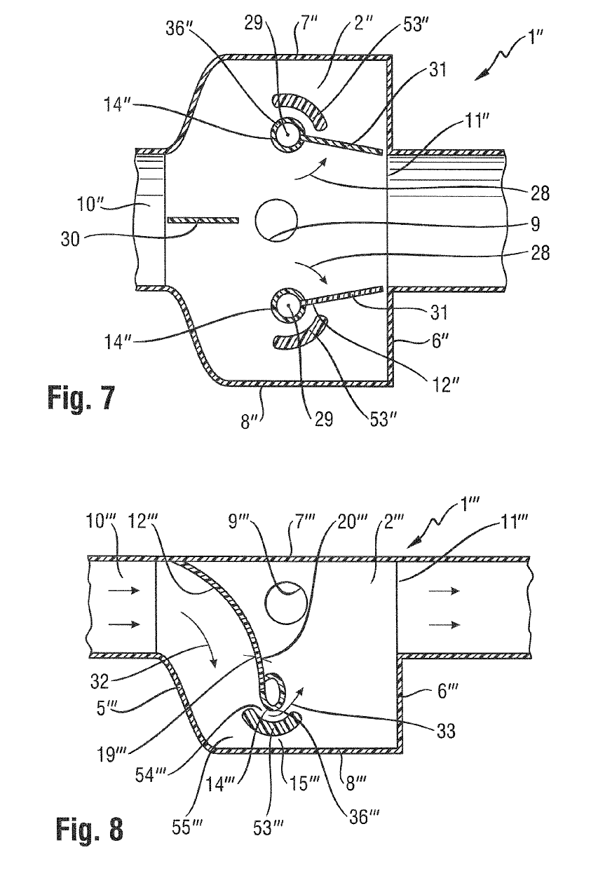

FIG. 7 shows the section according to FIG. 6 wherein here the deflection element is also in a non-active position,

FIG. 8 shows a horizontal section through a schematically shown water box according to the invention according to a further variant,

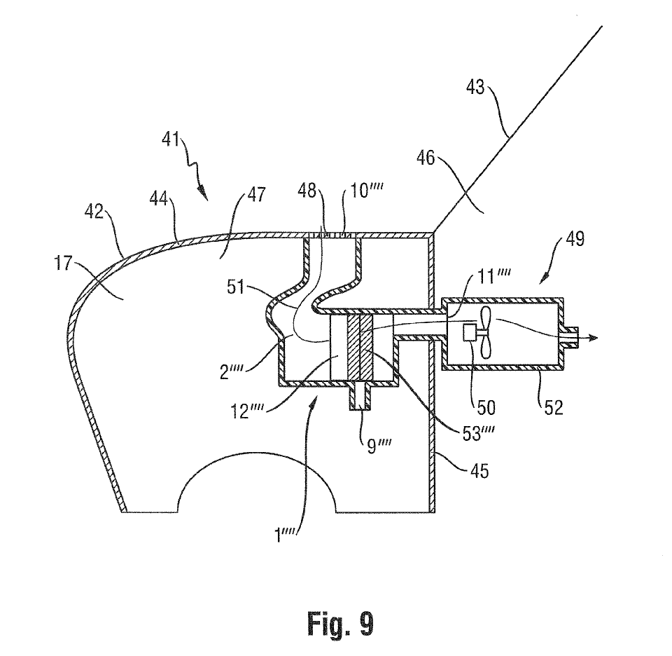

FIG. 9 shows a longitudinal section through a motor vehicle shown only very schematically with a water box according to the invention according to a further variant, and

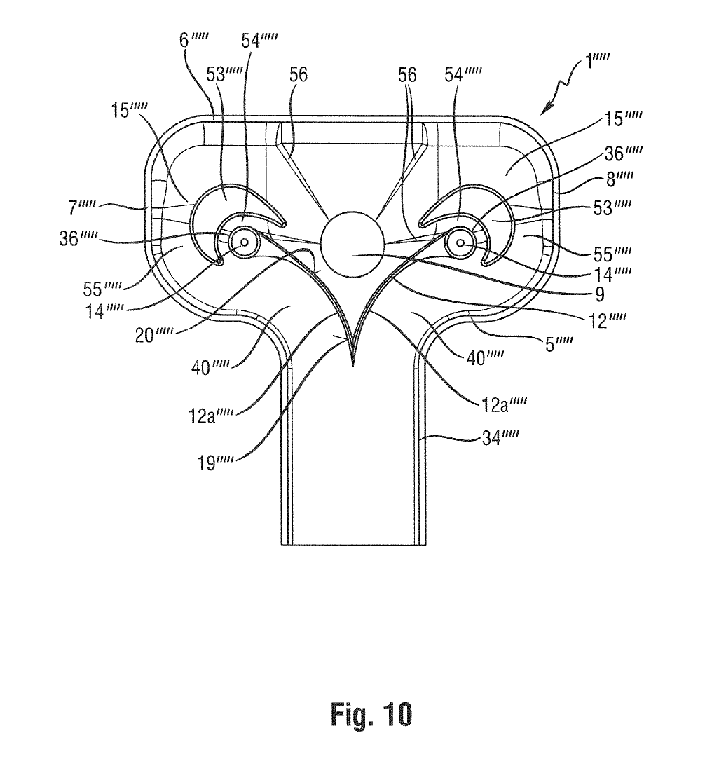

FIG. 10 shows a horizontal section through a schematically shown water box according to the invention according to a further variant.

The water box 1 shown in FIGS. 1 to 4 has a deflection chamber 2 which has a top wall 3, a bottom wall 4, a front wall 5, a rear wall 6 and two side walls 7 and 8 extending substantially parallel to one another. The front wall 5 has an air inlet opening 10 at which suctioned fresh air may be introduced into the deflection chamber 2. The front wall 5 is connected via a pipe 34 to a suction opening, not shown here, which is arranged for example below a windshield and is covered by a grille, not shown here. The pipe 34 may, as shown, be round in cross section. The cross section of the pipe 34 which forms an inlet pipe, however, may also have a different shape, for example the cross section may be rectangular. The air inlet opening 10 may also extend over the entire height of the front wall 5. In FIG. 1 the air thus flows from left to right into the deflection chamber 2. The transition regions between the pipe 34 and the front wall 5 as well as between the front wall 5 and the side walls 7 and 8 are in each case of rounded configuration. In the horizontal cross-sectional view according to FIG. 1, the front wall 5 and the pipe 34 form together a funnel shape.

The suctioned fresh air flows through the deflection chamber 2 and leaves this deflection chamber through an air outlet opening 11 which is arranged in the rear wall 6. This air outlet opening 11 is connected via a pipe 35 to a conventional air-conditioning unit, not shown here. The pipe 35 may also be circular in cross section or, for example, may also be rectangular. In the air-conditioning unit mentioned here, and not shown here, is generally located a fan for suctioning the fresh air, an air filter and means for heating and/or cooling the fresh air. The air-conditioning unit is preferably located in the passenger compartment whilst the water box 1, for example, is located in the engine compartment. The water box 1 is, as shown, substantially closed. The outflowing air flows in FIG. 1 from left to right. The inflowing air and the outflowing air thus flow substantially in the same direction. In the installed state this flow is substantially horizontal. In the deflection chamber 2 the fresh air, which is suctioned at the air inlet opening 10, is deflected such that it removes as much water as possible. The water may fall as splash water and/or droplets. A 2-phase flow may flow through the deflection chamber 2, therefore, which is the case, in particular in the event of rainy weather.

For removing the water, according to FIG. 1 a water drainage opening 9 is arranged in the bottom wall 4. This water drainage opening 9 is located behind a deflection element 12. The bottom wall 4 may be configured to be planar or even conical, so that the water drainage opening 9 is located at the lowest point of the bottom wall 4. The deflection element 12 is configured in the shape of a gabled roof and extends vertically from the top wall 3 to the bottom wall 4. The deflection element 12 bears with an upper face 16 continuously against the top wall 3 and bears with a lower face 17 continuously against the bottom wall 4. The deflection element consists of two substantially mirror-symmetrical parts 12awhich meet at a vertically extending front edge 18. The parts 12a have in each case a concave front face 19 and a convex rear face 20. Spaced apart from the front edge 18 the two parts 12a in each case have a side edge 13, also extending vertically. In each case a bead-shaped thickened portion 14 extending in the vertical direction is provided on these side edges 13. In the present variant the thickened portions 14 are in each case formed by means of a pipe provided with a slot, wherein one of the parts 12a protrudes with the entire side edge 13 into the slot and is held there. The thickened portions 14 form in each case with their outer faces remote from the parts 12a a rounded side edge 36 of the deflection element 12 extending in the vertical direction.

The parts 12a delimit together with the front wall 5 in each case an air channel 40. Thus a first air channel 40, as well as a second air channel 40 extending separately therefrom, are provided, said air channels in each case having a substantially uniform flow cross section relative to surface and shape along their longitudinal extent from the air inlet opening 10 to the respective flow opening 15 described below.

If fresh air is suctioned at the air inlet opening 10, therefore, this flows according to the arrows 21 toward the deflection element 12 and is subdivided at the front edge 18 substantially into equal parts and mirror-symmetrically. The two partial flows flow through the air channels 40 and flow approximately in a circular manner in each case around the corresponding thickened portion 14 and pass downstream of the deflection element 12. Splash water is deflected on the deflection element 12 and finally passes along the bottom wall 4 into the water drainage opening 9. In this case, in the known manner, the Coand\check{a} effect becomes effective. The water droplets and spray transported with the fresh air come into contact at the front faces 19. These water droplets flow downwardly along the front faces 19 and finally enter the water drainage opening 9 through which they leave the deflection chamber 2. The fresh air, splash water and substantially also water droplets having been removed therefrom, enters the air outlet opening 11 according to the arrows 22 and finally the air-conditioning unit, not shown here.

So that the fresh air is able to flow around the deflection element 12, a flow opening 15 is present between the side edges 36 of the deflection element which are formed by the thickened portions 14 and a side wall 7 and/or side wall 8. The spacing between the two thickened portions 14 is substantially larger than the spacing of the thickened portions 14 relative to the next side wall 8 and/or 7. Preferably, these flow openings 15 in each case extend over the entire height of the deflection chamber 2 and thus in each case from the bottom wall 4 to the top wall 3.

In each case a guide structure 53 is provided in the flow openings 15 between the side edge 36 and the side wall 7 and/or 8. The guide structures 53 extend in each case from the bottom wall 4 to the top wall 3 in the vertical direction. In the horizontal cross-sectional view (FIG. 1) the guide structures 53 in each case are designed to be kidney-shaped and extend over an angular range of ca. 90° around the side edge 36 so that air which flows through the deflection chamber 2 is guided by the guide structures 53 around the side edges 36. The curved shape of the guide structures 53 in cross section produces, in particular, the Coand\check{a} effect. By the presence of the guide structures 53 substantially less air turbulence is produced in the region of the side edges 36, whereby the pressure drop is reduced relative to the air flowing through the deflection chamber 2.

The guide structures 53 in each case are spaced apart from the side edge 36 and the side wall 7 and/or 8 of the deflection chamber 2. As a result, the guide structures 53 subdivide the flow opening 15 in each case into an inner air through-opening 54 and an outer air through-opening 55. The flow cross section of the outer air through-opening 55 is dimensioned in this case to be larger than that of the inner air through-opening 54. The guide structures 53 in each case have an inner surface facing the side edge 36, as well as an outer surface facing the side wall 7 and/or 8 curved in the same direction as the inner surface. The inner surfaces of the guide structures 53 extend in each case substantially parallel to the outer surfaces of the thickened portions 14.

According to FIG. 4, the two parts 12a may in each case be pivotable around a pivot axis 25. The parts 12a may, in particular, be pivoted from the first position shown in FIG. 1 into the second position shown in FIG. 4. In the second position shown in FIG. 4, the two parts 12a are pivoted outwardly so that between said two parts a through-passage 37 is located. This through-passage 37 permits suctioned fresh air to be able to flow substantially unhindered through the deflection chamber 2 according to the arrows 23. The pivoting of the parts 12a in the direction of the arrows 24 is preferably achieved in that the pipes provided with a slot, which form the thickened portions 14 and which are fixedly connected to the parts 12aare rotated about their respective longitudinal central axes. The two parts 12a may, therefore, be pivoted in a manner similar to double doors. The pivoting may take place manually or even by motor. The position shown in FIG. 4 of the two parts 12a is thus provided if the suctioned fresh air is relatively dry, water removal therefore not being necessary. The pivoting may take place due to a sensor, not shown here, for example due to a moisture sensor. The pivoting is carried out, for example, based on a given value, for example a predetermined moisture content of the suctioned fresh air. The sensor may be arranged, for example, in the air inlet opening 10 or in the air outlet opening 11. The arrangement of the parts 12aaccording to FIG. 4, has the substantial advantage that the air resistance in the deflection chamber 2 is substantially less than in the arrangement according to FIGS. 1 to 3. As the resistance is substantially less, correspondingly less energy is required for the suction of the fresh air, for example by an electrically driven fan.

FIG. 5 shows a water box 1′ which, in principle, is configured in a manner similar to the water box 1. The thickened portions 14′ provided here form, viewed in cross section, in each case a depression 38 which in each case is adjoined to a front face 19′. The thickened portions 14′, which are formed to be approximately droplet-shaped in cross section, are configured such that they produce a particularly effective Coand\check{a} effect. Splash water and water droplets deposited on the front face 19′, therefore, may flow particularly efficiently according to the arrows 26 around the deflection element 12 and may be guided into the water drainage opening 9. The dry air may leave the water box 1′ according to the arrows 27′. The water box 1′, as is shown, additionally has rounded edges 39 which connect the front wall 5′ to the side walls 7′ and 8′ and/or the rear wall 6′ to the side wall 7′ and/or 8′ and/or the pipe 34′ to the front wall 5′. These rounded edges 39 also reduce the resistance in the deflection chamber 2′ and additionally improve the diversion of water into the water drainage opening 9. In this case, the two parts 12a′ may also be pivotable. This is, however, not obligatory. In this case, the two parts 12a′ may also be fixedly mounted. This also applies to the parts 12a of the water box 1. Also in each case a guide structure 53′ is provided in the flow openings 15′, said guide structure extending around the side edge 36′ of the deflection element 12′ so that the guide structures 53′ in each case are arranged at least partially downstream in the airflow relative to the deflection element 12′. The guide structures 53′ subdivide the flow openings 15′ in each case into an inner air through-opening 54′ and an outer air through-opening 55′. The air channels 40′ which are defined in each case by a part 12a′ and the front wall 5′, as well as the inner air through-openings 54′ have along their respective longitudinal extent in each case a substantially uniform flow cross section relative to shape and surface.

The water box 1″ shown in FIGS. 6 and 7 has a deflection element 12″ which is configured to be star-shaped when viewed in section. The deflection element 12″ consists of a fixedly mounted wall 30 and two wall-shaped parts 31 which are pivotable to a limited extent. The parts 31 are in each case connected to a vertically arranged pipe which forms a thickened portion 14″ of the deflection element 12″ provided with a side edge 36″. These pipes may in each case be pivoted together with the part 31 from the position shown in FIG. 6 about a longitudinal central axis 29 into the position shown in FIG. 7. This pivoting is indicated in FIG. 7 by the arrows 28. If the parts 31 according to FIG. 7 are pivoted away, they extend substantially parallel to the flow direction. In the arrangement according to FIG. 7, the fresh air may pass with very low resistance from the air inlet opening 10″ to the air outlet opening 11″. The position according to FIG. 7 is also provided here in the case of relatively dry external air. A guide structure 53″ is arranged in the flow openings 15″, in each case between the side edge 36″ and the side wall 7″ and/or 8″, said guide structure extending around the respective side edge 36″ and subdividing the flow opening 15″ into an inner air through-opening 54″ and an outer air through-opening 55″.

The water box 1′″ according to FIG. 8 has a deflection element 12′″ which extends from a side wall 7′″ inwardly into a deflection chamber 2′″. The deflection element 12′″ has a concave front face 19′″ and a convex rear face 20′″. A bead-shaped thickened portion 14′″ is arranged at a free edge extending vertically on the deflection element 12′″. The concave front face 19′″ and the thickened portion 14′″ adjacent thereto are configured to be rounded with regard to the Coand\check{a} effect. Water and fresh air thus pass according to the arrow 32 at the front face 19′″ along the thickened portion 14′″ and flow around these portions according to arrow 33. Water and fresh air in this case flow through a flow opening 15′″ which is located between the side edge 36′″ of the deflection element 12′″ formed by the thickened portion 14′″ and a side wall 8′″. Finally, the removed water is guided along the convex rear face 20′″ to the water drainage opening 9′″. The fresh air finally passes through the air outlet opening 11′″ to the air-conditioning unit, not shown. The air inlet opening 10′″ and the air outlet opening 11′″ are also arranged opposite one another.

The suctioned fresh air also flows substantially horizontally through the deflection chamber 2′″. The deflection element 12′″ may be arranged fixedly or even pivotably. In order to avoid turbulence of the air in the region of the side edge 36′″ formed by the thickened portion 14′″, a guide structure 53′″ is arranged in the flow opening 15′″. Together with the outer surface of the thickened portion 14′″ this guide structure defines an inner air through-opening 54′″ and together with the side wall 8′″ an outer air through-opening 55′″.

The motor vehicle 41, shown by way of example and very schematically in FIG. 9, has in the conventional manner a body 42, a windshield 43 and an engine hood 44. A grille 48 is arranged in an opening of the engine hood 44. A front wall 45 separates the interior of the motor vehicle 41 into a passenger compartment 46 and an engine compartment 47. A water box 1″″ is arranged below the engine hood 44 in an engine compartment 47. The water box 1″″ has an air inlet opening 10″″, an air outlet opening 11″″, a water drainage opening 9″″ as well as a deflection chamber 2″″. A deflection element 12″″ as well as a guide structure 53″″ is arranged in the deflection chamber 2″″. The water box 1″″ extends through an opening in the front wall 45 and is connected to an air suction device 49 which is arranged in the passenger compartment 46 and which discharges into the passenger compartment 46. A fan 50 is arranged in the housing 52 of the air suction device 49. By means of the fan 50, as indicated by the arrow 51, at the air inlet opening 10″″ of the water box 1″″ air is suctioned, transported through the water box 1″″ and through the air suction device 49 and discharged into the passenger compartment. On the deflection element 2″″ the air flowing through the water box 1″″ is deflected so that as far as possible water is removed and leaves the water box 1″″ via the water drainage opening 9″″. Due to the guide structure 53″″ air turbulence in the region of the deflection element 2″″ is substantially avoided. Splash water entering via the air inlet opening 10″″ into the water box 1″″ is also removed via the water drainage opening 9″″ from the water box 1″″. Additionally, in the air suction device 49 a heating device, not shown here, and/or a cooling device may be present for the suctioned air, as known per se from the prior art.

The water box 1′″″ shown in FIG. 10 has a deflection element 12′″″ which is mirror-symmetrical in cross section, in which the thickness of the two parts 12a′″″ in each case increases toward the side edges 36′″″ continuously and by a multiple. The bead-shaped thickened portions 14′″″ forming the side edges 36′″″ in each case have an outer surface with a cross section which is of circular design over an angular range of more than 180°, and merges in a streamlined manner, i.e. without edges, with the front face 19′″″ and/or the rear face 20′″″ of the parts 12a′″″. This shape of the deflection element 12′″″ in the regions of the flow openings 15′″″ is particularly suitable for achieving as far as possible a laminar air flow relative to the air flowing past the deflection element 12′″″. A guide structure 53′″″ is arranged in each case in the flow openings 15′″″ said guide structure being of sickle-shaped design and extending by ca. 180° around the side edge 36′″″. In the region arranged downstream in the airflow from the deflection element 12′″″ the two guide structures are configured such that they extend with their respective ends in the direction of the water drainage opening 9 so that they guide the air flowing through the water box 1′″″ to the water drainage opening 9.

The transition regions of the water box 1′″″ between the pipe 34 ′″″ and the front wall 5′″″, between the front wall 5′″″ and the side wall 7′″″ and/or 8′″″, as well as between the side wall 7′″″ and/or and the rear wall 6′″″ in each case are of rounded configuration. The parts 12a′″″ define together with the transition regions between the pipe 34′″″ and the front wall 5′″″ in each case an air channel 40′″″. Thus two air channels 40′″″ extending separately from one another are present, said air channels in each case having a substantially uniform cross section relative to shape and surface, so that a substantially laminar air flow is achieved in each case in the air channels 40′″″. In order to avoid air turbulence in the regions of the flow openings 15′″″, in each case as far as possible, the inner and outer air through-openings 54′″″and 55′″″ between the guide structures 53′″″ and the respective outer surface of the thickened portion 14′″″ and/or between the guide structures 53′″″ and the respective side wall 7′″″ and/or 8′″″ also have in each case a substantially uniform cross section relative to shape and surface.

A plurality of webs 56 are attached to the upper face of the bottom wall 4 of the water box 1′″″ in order to conduct water which collects on the floor of the deflection chamber 2′″″ to the water drainage opening 9.

List of Reference Numerals

1 Water box

2 Deflection chamber

3 Top wall

4 Bottom wall

5 Front wall

6 Rear wall

7 Side wall

8 Side wall

9 Water drainage opening

10 Air inlet opening

11 Air outlet opening

12 Deflection element

12a Part

13 Side edge

14 Thickened portion

15 Flow opening

16 Upper face

17 Lower face

18 Front edge

19 Front face

20 Rear face

21 Arrow

22 Arrow

23 Arrow

24 Arrow

25 Pivot axis

26 Arrow

27 Arrow

28 Arrow

29 Pivot axis

30 Wall

31 Part

32 Arrow

33 Arrow

34 Pipe

35 Pipe

36 Side edge

37 Through-passage

38 Depression

39 Edges

40 Air channel

41 Motor vehicle

42 Body

43 Windshield

44 Engine hood

45 Front wall

46 Passenger compartment

47 Engine compartment

48 Grille

49 Air suction device

50 Fan

51 Arrow

52 Housing

53 Guide structure

54 Inner air through-opening

55 Outer air through-opening

56 Web

1. A water box for a motor vehicle comprising a deflection chamber which comprises a top wall, a bottom wall with a water drainage opening, at least one side wall, an air inlet opening and an air outlet opening, a deflection element which comprises a side edge and which is arranged in the deflection chamber, wherein air flowing through the air inlet opening and loaded with water droplets is deflected on the deflection element, wherein the air inlet opening is arranged in the top wall and/or a front wall of the deflection chamber and the air outlet opening is arranged in the top wall and/or in a rear wall of the deflection chamber, wherein a flow opening is arranged between the at least one side wall of the deflection chamber and the side edge of the deflection element, and wherein at least one guide structure is provided in the deflection chamber in the region of the flow opening in order to guide air which flows through the deflection chamber around the side edge of the deflection element.

2. The water box as claimed in claim 1, wherein the guide structure is arranged at least partially downstream in the airflow relative to the deflection element.

3. The water box as claimed in claim 1, wherein the deflection element and/or the guide structure extend substantially from the top wall to the bottom wall.

4. The water box as claimed in claim 1, wherein the guide structure extends in cross section over an angular range of at least 90° and, in particular, at most 180° around the side edge of the deflection element.

5. The water box as claimed in claim 1, wherein the guide structure is sickle-shaped in cross section.

6. The water box as claimed in claim 1, wherein the deflection element in cross section has a thickness which in a region arranged adjacent to the flow opening increases toward the side edge by a multiple and, in particular, continuously.

7. The water box as claimed in claim 1, wherein the water box has an inlet pipe which opens into the air inlet opening of the deflection chamber, and wherein a transition region of rounded configuration is provided between the inlet pipe and the deflection chamber.

8. The water box as claimed in claim 1, wherein the water drainage opening is arranged between the deflection element and the rear wall.

9. The water box as claimed in claim 1, wherein the deflection element has a second side edge which forms a second flow opening with a second side wall of the deflection chamber, and wherein preferably in the deflection chamber at least one second guide structure is present in the region of the second flow opening in order to guide air which flows through the deflection chamber around the second side edge of the deflection element.

10. The water box as claimed in claim 9, wherein the deflection chamber and the deflection element together form at least one, first air channel as well as a second air channel extending separately from the first air channel, and wherein preferably the first air channel and the second air channel in each case have a substantially uniform flow cross section relative to surface and shape.

11. The water box as claimed in claim 10, wherein the first air channel extends substantially from the air inlet opening to the first flow opening and the second air channel extends substantially from the air inlet opening to the second flow opening.

12. The water box as claimed in claim 1, wherein the guide structure is arranged spaced apart from the deflection element and/or spaced apart from the side walls of the deflection chamber.

13. The water box as claimed in claim 1, wherein an inner air through-opening is provided in the region of the flow opening between the guide structure and the side edge of the deflection element and wherein an outer air through-opening is provided between the guide structure and the side wall of the deflection chamber, said outer air through-opening being preferably dimensioned so as to be larger in comparison with the inner air through-opening.

14. The water box as claimed in claim 1, wherein the deflection element is configured to be in the shape of a gabled roof or pitch roof, and wherein the ridge extends substantially vertically.

15. The water box as claimed in claim 1, wherein the deflection chamber has at least partially rounded edges.

16. The water box as claimed in claim 1, wherein the deflection element and/or the guide structure are configured such that water and/or air is conducted according to the Coand\check{a} effect.

17. A motor vehicle with a passenger compartment, an air suction device and a water box, the water box comprising a deflection chamber which comprises a top wall, a bottom wall with a water drainage opening, at least one side wall, an air inlet opening and an air outlet opening,
a deflection element which comprises a side edge and which is arranged in the deflection chamber, wherein air flowing through the air inlet opening and loaded with water droplets is deflected on the deflection element,
wherein the air inlet opening is arranged in the top wall and/or a front wall of the deflection chamber and the air outlet opening is arranged in the top wall and/or in a rear wall of the deflection chamber,
wherein a flow opening is arranged between the at least one side wall of the deflection chamber and the side edge of the deflection element,
wherein at least one guide structure is provided in the deflection chamber in the region of the flow opening in order to guide air which flows through the deflection chamber around the side edge of the deflection element,
and wherein the water box is attached at the air outlet opening to the air suction device, fresh air suctioned at the air inlet opening being able to be discharged thereby into the passenger compartment.
